(19) United States
(12) Patent Application Publication
(10) Pub. No.: US 2024/0236061 A1
(43) Pub. Date: Jul. 11, 2024

(54) CENTRALIZED LOCATION-BASED NETWORK CONNECTIVITY MANAGEMENT PLATFORM

(71) Applicant: RAKUTEN MOBILE, INC., Tokyo (JP)

(72) Inventors: Rina TAKAMATSU, Tokyo (JP); Sourabh SHUKLA, Indore (IN); Harsh SONI, Indore (IN); Shubham PARDE, Indore (IN); Rishi SHARMA, Indore (IN); Sanyam MADAAN, Tokyo (JP)

(73) Assignee: RAKUTEN MOBILE, INC., Tokyo (JP)

(21) Appl. No.: 17/801,351

(22) PCT Filed: Jun. 21, 2022
(86) PCT No.: PCT/US2022/034244

§ 371 Date: Aug. 22, 2022

(51) Int. Cl. H04L 9/40

(52) U.S. Cl. CPC H04L 63/08; H04L 63/107

(57) ABSTRACT

A method and system of managing network connectivity via a centralized platform. The method can include receiving login credentials from a first user, authenticating the first user, and receiving a first data request from the first user, wherein the first data request includes geo-location information with respect to network connectivity of one or more network components. In addition, the method may include displaying via a graphical user interface a first geographical map including a visual representation of one or more regions indicating a status with respect to network connectivity of the one or more network components. Further, the one or more regions may include one or more layers, wherein each layer is associated with at least one network connectivity related event.

### BACKGROUND

### Technical Field

Apparatuses and methods consistent with example embodiments of the present disclosure relate to a centralized location-based network connectivity management platform.

### Background

Generally, communication service providers can monitor and manage their telecommunication networks to ensure that network components and network resources are functioning properly in order to provide continued service to their customers. In traditional distributed computing and network systems, a service provider may provide network maintenance by probing or pinging a remotely located server to ensure that packages are able to pass between two end-points. However, when a network outage or fault occurs, the communication service provider may not be able to initially determine which individual components are not functioning properly due to the large number of network components and the relationships between these network components.

In particular, one of the difficulties can be in detecting, diagnosing, and remedying network related outage problems, particularly when such initial service requests or outage complaints by customers are handled by a customer support team member who is not technically versed nor trained in detecting, diagnosing, or remedying the customer's network connection problems. Such network connection or outage problems could be due to a variety of circumstances, such as adverse weather effects on physical components of a network of managed resources and components, equipment failures, user errors, software incompatibilities, and the like. Many of these conditions are very difficult to detect through traditional means, which often include engaging various customer support teams, who may check their individual areas of responsibility to determine if their equipment or resources caused the problems, thereby creating a very inefficient system. Moreover, neither the customer nor the customer support team member are able to view an overview of location based outages in near-real time in a simple and easy to understand manner. Accordingly, neither the customer nor the customer support team member have all relevant information before them for handling outages or network connectivity problems.

Hence, there is a need to provide a centralized network connectivity management platform that can allow both customers and customer support team members to manage, monitor, and view network outages or connectivity problems based on location that is simple to use, efficient, and improves overall customer satisfaction.

### SUMMARY

According to example embodiments, a centralized location-based network connectivity management tool system and method is disclosed that can allow both customers and customer support team members to manage and view network outages or connectivity problems on a graphical user interface map based on location, and that is simple to use and evaluate, minimizes or eliminates time or resources spent communicating between customer support teams in various organizational departments, and improves overall customer satisfaction, among other advantages.

According to example embodiments, a method of managing network connectivity via a centralized platform is disclosed, the method including receiving login credentials from a first user; authenticating the first user; and receiving a first data request from the first user, wherein the first data request includes geo-location information with respect to network connectivity of one or more network components.

The method may also include wherein the geo-location information includes at least one of: a residential or commercial address, building or structure location, city, state, province, district, or prefecture.

In addition, the geo-location information may also include a defined location range, location vicinity, or location area.

The method may also include converting the geo-location information within the first data request to latitude and longitude coordinates.

Further, the method may include displaying via a graphical user interface a first geographical map including a visual representation of one or more regions indicating a status with respect to network connectivity of the one or more network components.

Also, the one or more regions may include one or more layers, wherein each layer is associated with at least one network connectivity related event.

Further, each of the one or more layers may include independent indicia or independent color-coding relative to each other.

The method may also include receiving a second data request from the first user, wherein the second data request includes geo-location information with respect to one or more third party vendors or service providers; and displaying via the graphical user interface a second map including a visual representation of the locations of the one or more third party vendors or service providers.

In addition, the method can include receiving a request from the first user or a second user to create a service request with respect to the network connectivity of the one or more network components associated with the first user.

Further, the method can include receiving geo-location information with respect to network connectivity of the one or more network components from one or more online social media publications.

According example embodiment, an apparatus for managing network connectivity via a centralized platform is disclosed, including a memory storage storing computer-executable instructions; and a processor communicatively coupled to the memory storage, wherein the processor is configured to execute the computer-executable instructions and cause the apparatus to: receive login credentials from a first user; authenticate the first user; and receive a first data request from the first user, wherein the first data request is comprised of geo-location information with respect to network connectivity of one or more network components.

In addition, the apparatus may include wherein the geo-location information includes at least one of: a residential or commercial address, building or structure location, city, state, province, district, or prefecture.

Further, the apparatus may include wherein the geo-location information includes a defined location range, location vicinity, or location area.

Also, the computer-executable instructions, when executed by the processor, may further cause the apparatus to: convert the geo-location information within the first data request to latitude and longitude coordinates.

In addition, the computer-executable instructions, when executed by the processor, may further cause the apparatus to: display via a graphical user interface a first geographical map comprising a visual representation of one or more regions indicating a status with respect to network connectivity of the one or more network components.

Further, the apparatus may further include wherein the one or more regions include one or more layers, wherein each layer is associated with at least one network connectivity related event.

The apparatus may also include wherein each of the one or more layers include independent indicia or independent color-coding relative to each other.

Further, the computer-executable instructions, when executed by the processor, may further cause the apparatus to: receive a second data request from the first user, wherein the second data request includes geo-location information with respect to one or more third party vendors or service providers; and display via the graphical user interface a second map including a visual representation of the locations of the one or more third party vendors or service providers.

In addition, the computer-executable instructions, when executed by the processor, may further cause the apparatus to: receive a request from the first user or a second user to create a service request with respect to the network connectivity of one or more network components associated with the first user.

According to example embodiments, a non-transitory computer-readable medium comprising computer-executable instructions for managing network connectivity via a centralized platform via a centralized platform by an apparatus is disclosed, wherein the computer-executable instructions, when executed by at least one processor of the apparatus, cause the apparatus to: receive login credentials from a first user; authenticate the first user; and receive a first data request from the first user, wherein the first data request is comprised of geo-location information with respect to network connectivity of one or more network components.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture of the centralized location-based network connectivity management platform system and method of the disclosure described herein according to one or more embodiments;

FIG. 2 illustrates another diagram of a system architecture of the centralized location-based network connectivity management platform system and method of the disclosure described herein according to one or more embodiments;

FIG. 3 illustrates a flowchart of the centralized location-based network connectivity management platform system and method of the disclosure described herein according to one or more embodiments;

FIG. 4 illustrates a diagram of components and modules of the centralized location-based network connectivity management platform system and method of the disclosure described herein according to one or more embodiments;

FIG. 5 illustrates another diagram of components and modules of the centralized location-based network connectivity management platform system and method of the disclosure described herein according to one or more embodiments;

FIG. 6A illustrates a graphical user interface map and portal of the centralized location-based network connectivity management platform system and method of the disclosure described herein according to one or more embodiments;

FIG. 6B illustrates a graphical user interface map and portal of a search feature of the centralized location-based network connectivity management platform system and method of the disclosure described herein according to one or more embodiments;

FIG. 7A illustrates a graphical user interface map and portal of third party vendor and service repair centers of the centralized location-based network connectivity management platform system and method of the disclosure described herein according to one or more embodiments; and

FIG. 7B illustrates a graphical user interface map and portal of pending customer service requests of the centralized location-based network connectivity management platform system and method of the disclosure described herein according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

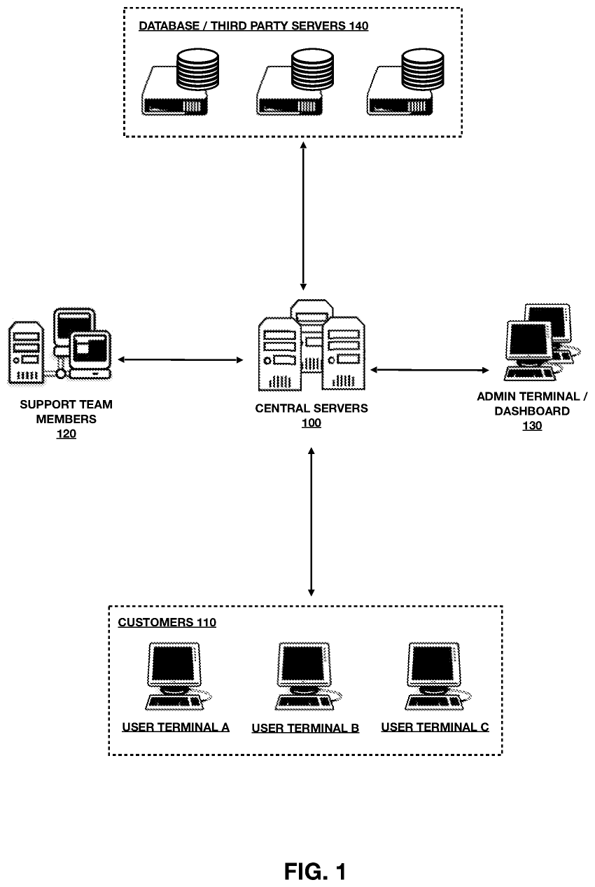

FIG. 1 illustrates a diagram of a general network architecture according to one or more embodiments. Referring to FIG. 1, customers 110, support team members 130, and admin terminal/dashboard (also collectively referred to herein as users 110, 120, and 130) can be in bi-directional communication over a secure network with central servers or application servers 100 according to one or more embodiments. In addition, users 110, 120, 130 may also be in direct bi-directional communication with each other via the network system of the disclosure described herein according to one or more embodiments. Here, users 110 can be any type of customer of a network or telecommunication service provider, such as users operating user terminals A, B, and C. Each of users 110 can communicate with servers 100 via their respective terminals or portals. Users 120 can be customer support members or agents of the network service provider for assisting and providing support services to customers 110. Admin terminal/dashboard 130 may be any type of user with access privileges for accessing a dashboard or management portal of the disclosure described herein, wherein the dashboard portal can provide various user tools, maps, and customer support options. It is contemplated within the scope of the present disclosure described herein that any of users 110 and 120 may access the admin terminal/dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors or repair centers that can provide various types of network diagnostic, installation, maintenance, and repair services for a network service provider or its customers, such as on-site or off-site (remote) network services. However, it is contemplated within the scope of the present disclosure described herein that the centralized location-based network connectivity management system and method can include any type of general network architecture.

Still referring to FIG. 1, one or more of servers or terminals of elements 100-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be enabled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

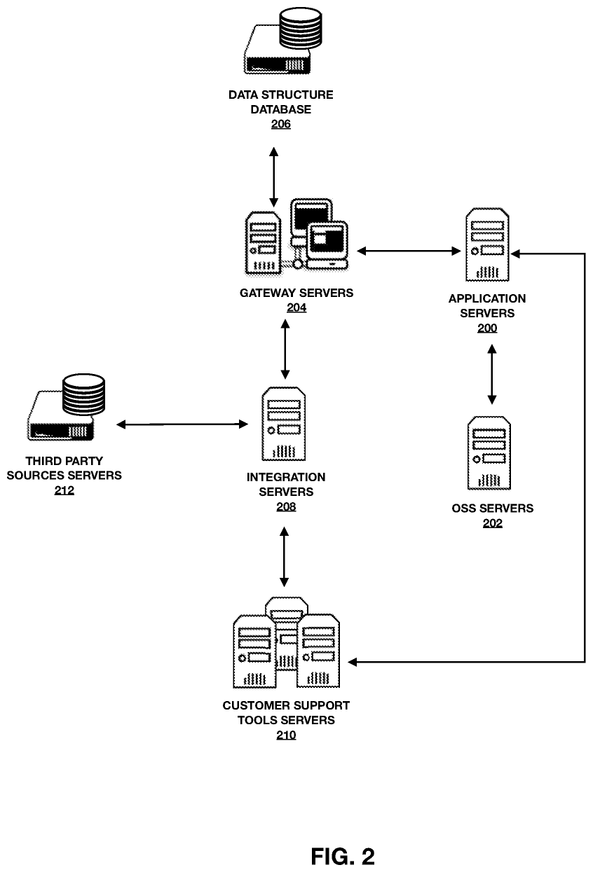

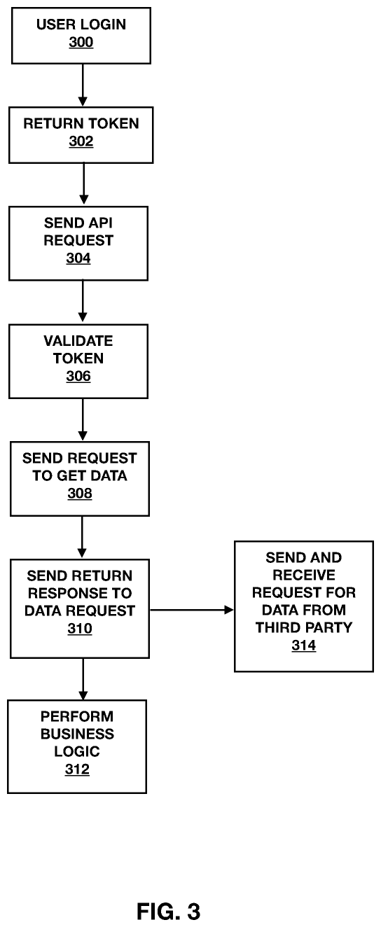

FIGS. 2-3 illustrate a network architecture and a corresponding process flow with respect to various modules, servers, components, and process steps of the centralized location-based network connectivity management platform system and method of the disclosure described herein. In particular, the process of the disclosure described herein can begin at step 300, where the user can login to a portal or dashboard of the centralized location-based network connectivity management platform system and method of the disclosure described herein via application servers 200. After login, the application servers 200 can send the user credentials to Object Storage Servers (OSS) servers 202, which then at step 302 return a token back to the application servers 200. Next, at step 304, the application servers 200 can send an Application Programming Interface (API) request to gateway servers 204. Next, at step 306, gateway servers 204 can send a validation of the token to data structure database 206 (such as a “Redis” database). Once the token is validated, then the user has permission to access any specific API or feature of the platform of the disclosure described herein. Next, at step 308, any user of the centralized location-based network connectivity management platform system and method of the disclosure described herein can request data (such as location-based network outage information or geo-location information related to connectivity of one or more network components of the service provider) at the gateway servers 204, wherein gateway servers 204 request the user requested data from integration servers 208. Here, such requested location data can be in the form of a location area, location range, location vicinity, location area, city, territory, province, prefecture, district, and geo-location coordinates such as latitude and longitude. In addition, the process can convert any requested location related information to specific latitude and longitude coordinates. Next, at step 310, the process can send the user requested data to customer support tools servers 210 from integration servers 204 via a return response, wherein the user can view the requested data on a dashboard of portal of the disclosure described herein, such as a GUI map of network outage information with respect to one or more requested locations.

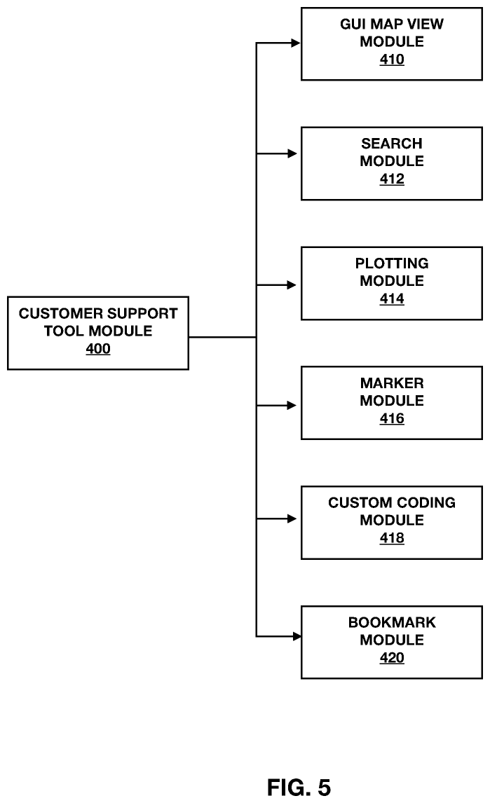

Still referring to FIGS. 2-3, at step 312, the process can perform various types of business logic or additional processes, such as providing the user the user the ability to search additional locations, and further provide plotting capabilities, marker capabilities, custom coding capabilities, and bookmarking location capabilities, which will be discussed in more detail with respect to FIGS. 5-7B. In addition, at step 314 the process can also optionally request to get or fetch data via integration servers 208 from one or more third parties at third party sources servers 212, wherein the third party servers send the requested data back to integration servers 208. Here, such requested data can pertain to service or repair requests from one or more third party vendors or repair centers of a network service provider (including in-network vendors or out-of-network vendors), such as requesting maintenance or repair with respect to one or more components or network resources at a particular location. Alternatively, a user may request network outage or connectivity information for various locations from one or more third party vendor network providers, such as with respect to networks that are not within a service providers network (e.g., roaming networks).

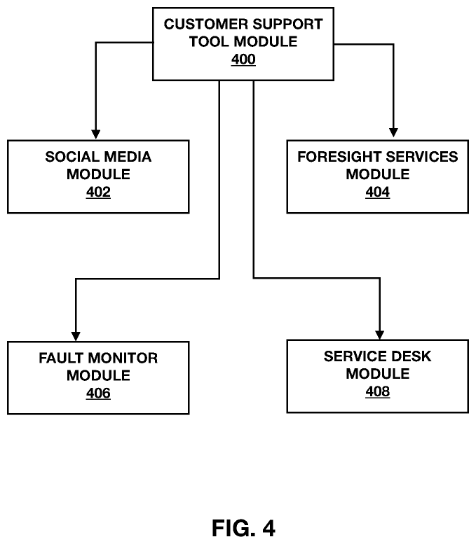

FIG. 4 illustrates various modules and components of the centralized network management platform of the disclosure described herein. In particular, customer support module 400 can include a social media module 402, wherein social media module 402 can fetch and obtain various location-based data from published social media related posts, articles, or stories (such as Twitter®, Instagram®, etc.) with respect to network outage and connectivity problems associated with one or more customers of the network service provider. In particular, if a user posts a network outage related post on his/her social media platform with respect to a service provider, then module 402 of the disclosure described herein can obtain tagged location or geo-location data with respect to the particular outage and display such outage on a GUI map. Further, customer support module 400 can also include a foresight services module 404, which can include planned network maintenance and repair (which may result in network downtime and connectivity issues), in addition to data about sites, geography, related network information, wherein the foresights services module 404 can further store the foregoing information for later retrieval. In addition, customer support module 400 can also include a fault monitor module 406 that can continuously monitor any faults or network connectivity issues, such as via pinging or probing end-to-end network connection resources or components within the service providers network to detect any active faults or connectivity issues. Further, customer support module 400 can also include a service desk module 408 that can allow a user (such as a customer support team member) to track, manage, notify, and follow network related connectivity issues. In addition, module 408 can allow the customer support team member to create service tickets for customers of the service provider with respect to their network connectivity problems, in addition to scheduling repair, diagnostics, and maintenance, among others,

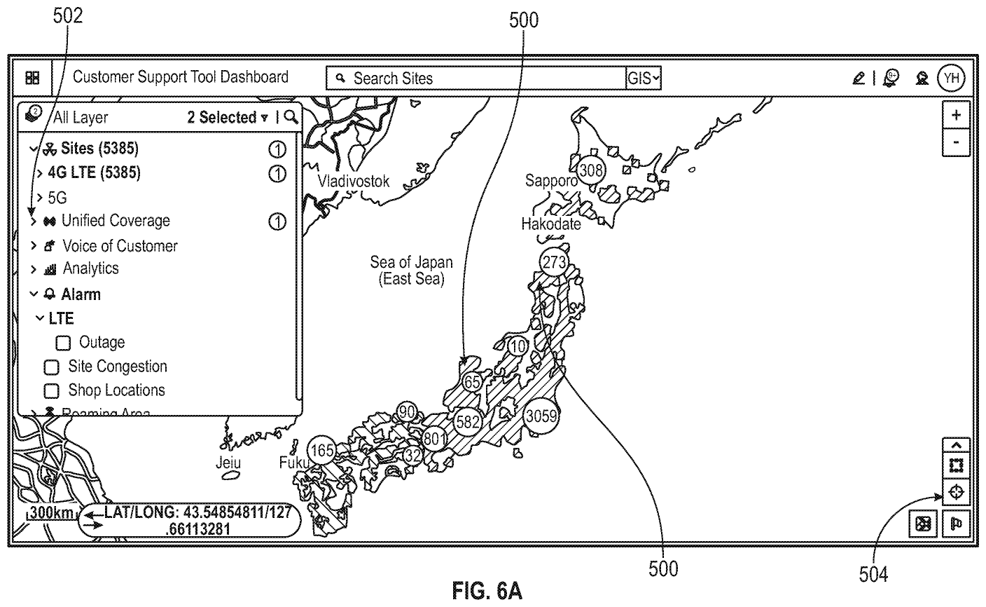

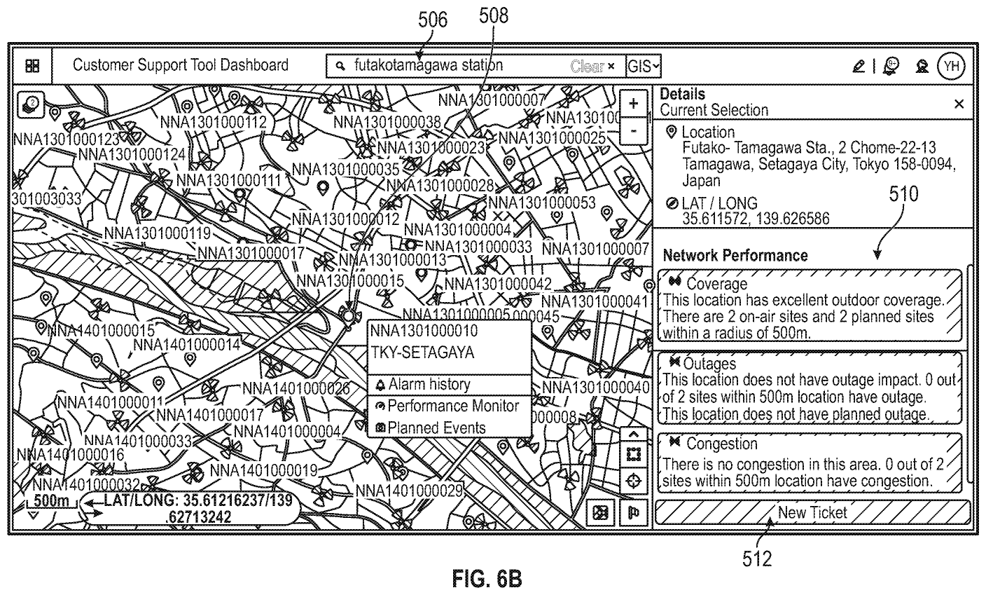

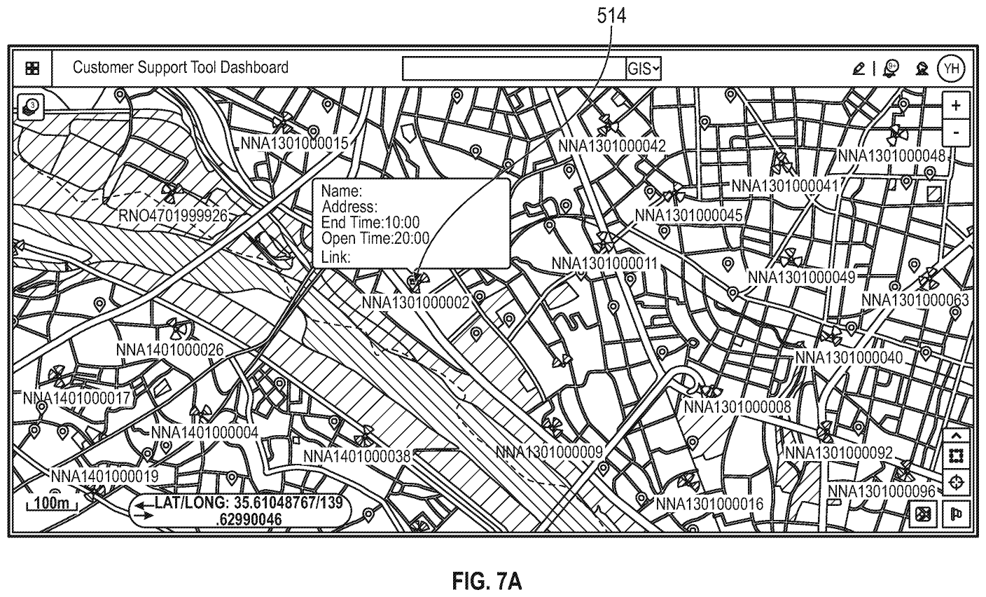

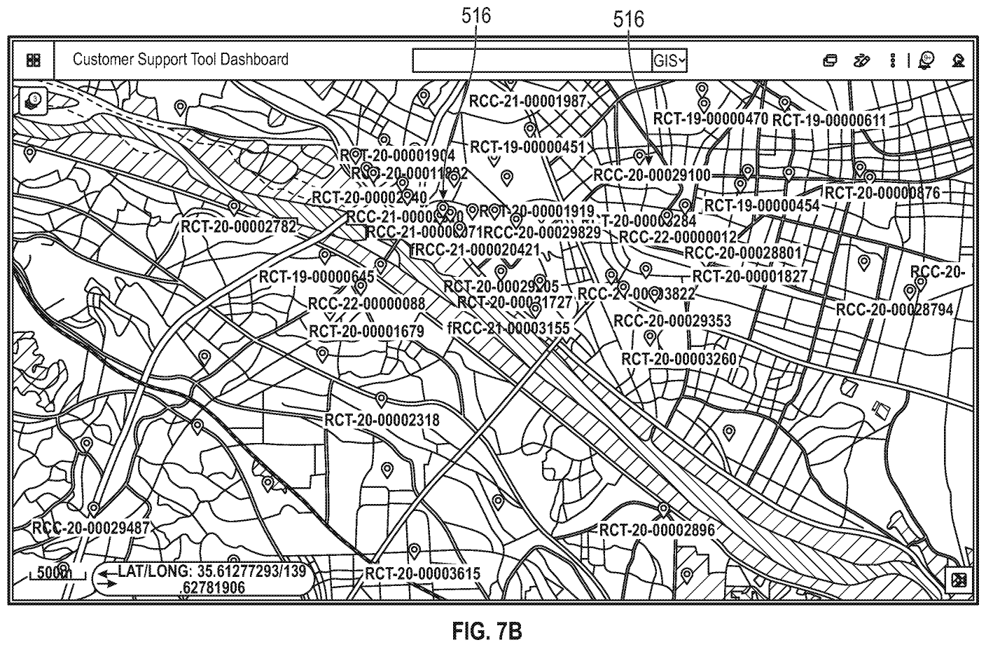

FIG. 5 illustrates additional modules and components of the centralized network management platform of the disclosure described herein. Here, customer support tool module 400 can further include a GUI map view module 410 that allows any user of the disclosure described herein to view location-based outages and network layers on a single view visual map, which may also be zoomed in and out at various zoom levels, such as shown in FIGS. 6A-7B. Further, customer support tool module 400 may also include a search module 412 that can allow the user to conduct a global search for any particular location, location ranges, location areas, location vicinity, address, business, dwelling, structure, city, or territory, among others. In addition, customer support tool module 400 may also include a plotting module 414, that plots the specific locations of network resources and outages on the GUI map, including network roaming areas, third party vendors for repair/maintenance, and open/pending/closed customer support tickets, social media post locations, among others, such as shown in FIGS. 6A-7B.

Still referring to FIG. 5, customer support tool module 400 may also include a marker module, that can allow the user to drag a GUI element on a map to view and obtain network connectivity information about a particular location, area, location perimeter, or location radius. Further, customer support tool module 400 may also include a custom coding module 418 that can allow a user to custom code various layers on the GUI map. For example, such custom coding can be for showing information pertaining to an intermittent outage in an “alarm” type of layer, such as illustrated in FIG. 6A in one exemplary embodiment. Customer support module 400 may also include a bookmark module 420 that can allow the user to bookmark or save one or more locations (or layer information), including the locations of customers, third party vendors, and the like.

FIG. 6A illustrates one exemplary embodiment of a GUI map of the centralized network management platform of the disclosure described herein, such as the customer support tool dashboard of module 400. In particular, the map can show highlighted or color-coded areas regions 500 that can show either normal connectivity, faults, or specific outages. For example, in one embodiment, depending on the selected layer, the map can show network outages (e.g., intermittent outages or severe outages) in color-coded areas depending on outage severity, such as red assigned to a high severity (such as a complete outage) and yellow assigned to low severity (such as intermittent outages), or any other type of indicia, among others. In addition, regions 500 may also indicate the number of customers that are experiencing an outage at one or more locations, or the number of customers being served by the service provider within the shown location or color-coded region, among others. Here, the customer support tool dashboard may also include a GUI menu region or option to select various layers to be shown on the map, such as outages, site congestions, shop (third party vendor) locations, coverage areas, alarms, voice of customers, customer feedback, customer service request tickets, customer tweets, and roaming areas, among others. Further, the customer support tool dashboard may also include a GUI menu area 504 for selecting a draggable marker GUI element to view a location range or location radius, flagging locations GUI element, and bookmarking locations GUI element, among others.

FIG. 6B illustrates another exemplary embodiment of a GUI map of the centralized network management platform of the disclosure described herein, such as the customer support tool dashboard of module 400. Here, the customer support tool dashboard may also include a global search box 506 that can allow the user to search for a specific location or point of interest to be viewed on the map. Here, once the location has been identified, and selected, such as location 508, the dashboard can display various information pertaining to that particular location, such as outage history, alarm history, performance monitoring (such as KPIs), and planned network maintenance or outage events, among others. In addition, another GUI region 510 can display network performance related information for the selected location, such as simple and easy to read visualized information pertaining to real-time or near real-time coverage area information, outage status information, and congestion information. In particular, region 510 can allow a customer support team member (who may not be technically versed or experienced) to provide a customer with pertinent information with respect to the customer's network related questions or problems, thereby improving overall customer satisfaction. Alternatively, the customer may also login to the customer support tool dashboard to view such information. Further, in a scenario where there is no outage/faults, planned outage event, or high network congestion, and the customer is still having network connectivity problems, then the customer support team member may create a service ticket via GUI element 512 for the customer in order to schedule diagnostics, repair, and/or maintenance services from within the dashboard. However, it is contemplated within the scope of the present disclosure described herein that a ticket or service request may also be created for a customer for any service or network connectivity related issue, such as per a customer's request or at the discretion of the support team member.

FIG. 7A illustrates another exemplary embodiment of a GUI map of the centralized network management platform of the disclosure described herein, such as the customer support tool dashboard of module 400. Here, the customer support tool dashboard can show various shops or third party support service vendors (such as for diagnostics, repair, maintenance, etc.) on the map, such as near or within the vicinity of a selected location or network outage. Here, once a particular vendor is selected, such as vendor 514, then the user may be able to view the vendors contact information and further schedule diagnostic or repair services through the customer support tool dashboard for the customer.

FIG. 7B illustrates another exemplary embodiment of a GUI map of the centralized network management platform of the disclosure described herein, such as the customer support tool dashboard of module 400. Here, the customer support tool dashboard can visually illustrate customer support tickets or service requests on the map, based on the customer's location. Here, such customer support tickets can be for either pending, open, or closed tickets. In particular, once the customer support team member (or the customer) create a ticket with respect to network connectivity issues for a particular location, then the map can illustrate the specific location of where that customer support ticket originated.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of managing network connectivity via a centralized platform, the method comprising:
a receiving login credentials from a first user;
authenticating the first user; and
receiving a first data request from the first user, wherein the first data request is comprised of geo-location information with respect to network connectivity of one or more network components.

2. The method of claim 1, wherein the geo-location information is comprised of at least one of: a residential or commercial address, building or structure location, city, state, province, district, or prefecture.

3. The method of claim 1, wherein the geo-location information is comprised of a defined location range, location vicinity, or location area.

4. The method of claim 1, further comprising:
converting the geo-location information within the first data request to latitude and longitude coordinates.

5. The method of claim 1, further comprising:
displaying via a graphical user interface a first geographical map comprising a visual representation of one or more regions indicating a status with respect to network connectivity of the one or more network components.

6. The method of claim 5, wherein the one or more regions comprise one or more layers, wherein each layer is associated with at least one network connectivity related event.

7. The method of claim 6, wherein each of the one or more layers comprise independent indicia or independent color-coding relative to each other.

8. The method of claim 5, further comprising:
receiving a second data request from the first user, wherein the second data request comprises geo-location information with respect to one or more third party vendors or service providers; and
displaying via the graphical user interface a second map comprising a visual representation of the locations of the one or more third party vendors or service providers.

9. The method of claim 5, further comprising:
receiving a request from the first user or a second user to create a service request with respect to the network connectivity of the one or more network components associated with the first user.

10. The method of claim 1, further comprising:
receiving geo-location information with respect to network connectivity of the one or more network components from one or more online social media publications.

11. An apparatus for managing network connectivity via a centralized platform, comprising:
a memory storage storing computer-executable instructions; and
a processor communicatively coupled to the memory storage, wherein the processor is configured to execute the computer-executable instructions and cause the apparatus to:
receive login credentials from a first user;
authenticate the first user; and
receive a first data request from the first user, wherein the first data request is comprised of geo-location information with respect to network connectivity of one or more network components.

12. The apparatus of claim 11, wherein the geo-location information is comprised of at least one of: a residential or commercial address, building or structure location, city, state, province, district, or prefecture.

13. The apparatus of claim 11, wherein the geo-location information is comprised of a defined location range, location vicinity, or location area.

14. The apparatus of claim 11, wherein the computer-executable instructions, when executed by the processor, further cause the apparatus to:
convert the geo-location information within the first data request to latitude and longitude coordinates.

15. The apparatus of claim 11, wherein the computer-executable instructions, when executed by the processor, further cause the apparatus to:
display via a graphical user interface a first geographical map comprising a visual representation of one or more regions indicating a status with respect to network connectivity of the one or more network components.

16. The apparatus of claim 15, wherein the one or more regions comprise one or more layers, wherein each layer is associated with at least one network connectivity related event.

17. The apparatus of claim 16, wherein each of the one or more layers comprise independent indicia or independent color-coding relative to each other.

18. The apparatus of claim 15, wherein the computer-executable instructions, when executed by the processor, further cause the apparatus to:
receive a second data request from the first user, wherein the second data request comprises geo-location information with respect to one or more third party vendors or service providers; and
display via the graphical user interface a second map comprising a visual representation of the locations of the one or more third party vendors or service providers.

19. The apparatus of claim 15, wherein the computer-executable instructions, when executed by the processor, further cause the apparatus to:
receive a request from the first user or a second user to create a service request with respect to the network connectivity of the one or more network components associated with the first user.

20. A non-transitory computer-readable medium comprising computer-executable instructions for managing network connectivity via a centralized platform via a centralized platform by an apparatus, wherein the computer-executable instructions, when executed by at least one processor of the apparatus, cause the apparatus to:
receive login credentials from a first user;
authenticate the first user; and
receive a first data request from the first user, wherein the first data request is comprised of geo-location information with respect to network connectivity of one or more network components.
